(19) United States
(12) Patent Application Publication
(10) Pub. No.: US 2018/0096443 A1
(43) Pub. Date: Apr. 5, 2018

(54) Online Bargaining System and Online Goods Promotion System

(71) Applicant: Paking Technology, Inc., Taipei City (TW)

(72) Inventors: Chih-Hung Lin, Taipei City (TW); E-Fu Kuo, Taipei City (TW); Kai-Lung Hua, Taipei City (TW)

(21) Appl. No.: 15/585,996

(22) Filed: May 3, 2017

(30) Foreign Application Priority Data
Oct. 4, 2016 (TW) 105132114

(51) Int. Cl. G06Q 50/18; G06Q 30/02

(52) U.S. Cl. CPC G06Q 50/188; G06Q 30/0253

(57) ABSTRACT

The invention provides an online bargaining system, which includes an online bargaining platform for allowing a client to send a bargaining service request on goods for sale in a near-end physical store to a cloud server, such that the cloud server may interact with the client through the online bargaining platform to process the bargaining service request. The invention further provides an online goods promotion system for allowing the client to interact with the cloud server through an online goods promotion platform and take part in goods promotions in the near-end physical store. The invention allows consumers when shopping in a physical store to have online interactions of real-time price bargaining and promotions on goods for sale with a business owning the physical store, making the physical store become a competitive advantage for both the business and consumers. The invention may further combine reality games with goods promotions and thus bring more fun when the consumers interact with the store.

### CROSS-REFERENCE TO RELATED APPLICATIONS

This application claims the priority of Republic of China Patent Application No. 105132114 filed on Oct. 4, 2016, in the State Intellectual Property Office of the R.O.C., the disclosure of which is incorporated herein by reference.

### BACKGROUND OF THE INVENTION

### Field of the Invention

The invention relates to e-commerce service technologies, and more particularly, to an online bargaining system and an online goods promotion system, by which a brick and mortar business may have real-time online interaction with consumers in a near-end physical store thereof.

### Descriptions of the Related Art

Brick and mortar businesses and e-commerce stores serve as different distribution channels and have their own advantages for consumers in respect of shopping experiences, ways of shopping and prices of goods. The brick and mortar business provides consumers with a shopping entertainment place and a service platform where the consumers may look and compare various physical goods in real life. This allows the consumers to feel physical goods and enjoy shopping with immense gratification. It however makes the brick and mortar business have higher operating costs than the e-commerce store, such that goods for sale in a physical store are usually more expensive than those in an online store. Accordingly the consumers tend to try out physical goods in the physical store and then purchase them from the online store.

Generally retailed prices of similar goods in different physical stores may be variable in consideration of costs of running the physical stores (such as rentals, labor costs, logistics costs and profit control). Despite these costs, the brick and mortar business might still have a certain margin for reducing the retailed prices of goods. It however does not have a competitive advantage because services about price bargaining and promotions for goods for sale in its physical store are not known to every consumer in real time and are hard to proceed at any time or whenever necessary. In other words, the brick and mortar business has to solve the problems of high operating costs, long operating periods, low efficiency and limited ways of servicing, before its services about price bargaining and promotions for goods can be performed effectively. This is an important topic in the art to endeavor.

### SUMMARY OF THE INVENTION

In view of the above problems with goods selling as encountered by a conventional brick and mortar business, a primary object of the invention is to provide an online bargaining system and an online goods promotion system, which may inform every consumer of services about price bargaining and promotions for goods in the physical store and proceeding with them in real time, making the physical store become a competitive advantage for both the business and consumers.

Another object of the invention is to provide an online bargaining system and an online goods promotion system, which may further combine reality games with goods promotions and thus bring more fun when the consumers interact with the store.

For the objects said above and for other objects, the invention provides an online bargaining system including: a business and a client. The business including at least one near-end physical store and a cloud server, wherein, the near-end physical store is for selling at least one item of goods, and includes: a locator provided in the near-end physical store and for outputting location information; and a goods label provided on the at least one item of goods and including goods identification information representing the at least one item of goods; and the cloud server includes: a database for storing the goods identification information representing the item of goods, and storing allowable prices and bargaining procedures for the at least one item of goods in the near-end physical store. The client including an online bargaining platform, wherein when the client is in the near-end physical store, through the online bargaining platform it receives the location information and reads goods identification information corresponding to an item of goods for price bargaining, so as to send a bargaining service request to the cloud server and provide the received location information and the read goods identification information; wherein, the cloud server further includes a bargaining processing module, wherein the bargaining processing module recognizes the item of goods for price bargaining according to the goods identification information read by the client, and recognizes the near-end physical store where the client is according to the location information received by the client, so as to search an allowable price and a bargaining procedure corresponding to the item of goods for price bargaining from the database, and interact with the client through the online bargaining platform to process the bargaining service request.

Preferably, for the online bargaining system said above, wherein when the client is in the near-end physical store, it sends identify information to the cloud server through the online bargaining platform, and the database further stores history bargaining records corresponding to the identify information, such that the bargaining processing module searches the history bargaining records from the database according to the identify information so as to interact with the client through the online bargaining platform and process the bargaining service request.

Preferably, for the online bargaining system said above, wherein the client further provides an expected price for the item of goods for price bargaining to the cloud server and sends the bargaining service request based on the expected price, and the bargaining processing module further determines a difference between the expected price and the allowable price of the item of goods for price bargaining and processes the bargaining service request according to the difference being determined and the bargaining procedure.

Preferably, for the online bargaining system said above, wherein the client further provides a third-party price for the item of goods for price bargaining to the cloud server and sends the bargaining service request based on the third-party price, and the bargaining processing module further determines a difference between the third-party price and the allowable price of the item of goods for price bargaining and processes the bargaining service request according to the difference being determined and the bargaining procedure.

Preferably, for the online bargaining system said above, wherein the database further stores the expected price or third-party price for the item of goods for price bargaining from the client, so as to allow the business to determine a reasonable price for the item of goods for price bargaining.

Preferably, for the online bargaining system said above, wherein the cloud server further includes a goods promotion module, wherein when the bargaining processing module processes the bargaining service request according to the bargaining procedure, it allows the goods promotion module to generate goods promotion means used for interacting with the client through the online bargaining platform in order to process the bargaining service request.

Preferably, for the online bargaining system said above, wherein the goods promotion means generated by the goods promotion module include goods promotion information for providing the client with promotion plans of similar or recommended items of goods corresponding to the item of goods for price bargaining, and include an augmented reality task designed based on the near-end physical store's environment, allowing the client when completing the augmented reality task to be entitled to discount plans on the item of goods for price bargaining or its similar or recommended items of goods.

The invention further provides an online goods promotion system including: a business and a client. The business including at least one near-end physical store and a cloud server, wherein, the near-end physical store is for selling at least one item of goods, and includes: a locator provided in the near-end physical store and for outputting location information; and the cloud server includes: a database for storing goods promotion procedures for the item of goods in the near-end physical store. The client including an online goods promotion platform, wherein when the client is in the near-end physical store, it receives the location information through the online goods promotion platform, and sends a goods promotion request to the cloud server and provides the received location information; wherein, the cloud server further includes a goods promotion module for recognizing the near-end physical store where the client is according to the location information received by the client, for searching the goods promotion procedures from the database to generate goods promotion means, and for interacting with the client through the online goods promotion platform to process the goods promotion request.

Preferably, for the online goods promotion system said above, wherein when the client is in the near-end physical store, it sends identity information through the online goods promotion platform to the cloud server, and the database further stores history purchase records corresponding to the identity information, such that the goods promotion module searches the history purchase records from the database according to the identity information, and interacts with the client through the online goods promotion platform to process the goods promotion request.

Preferably, for the online goods promotion system said above, wherein the goods promotion means generated by the goods promotion module include goods marketing information for providing promotion plans on the item of goods.

Preferably, for the online goods promotion system said above, wherein the goods promotion means generated by the goods promotion module include an augmented reality task designed based on the near-end physical store's environment, allowing discount plans on the item of goods to be provided by completing the augmented reality task.

Compared to the conventional technology, the present invention provides an online bargaining system and an online goods promotion system, which provide an online service platform allowing a client to have online interactions on goods real-time price bargaining and goods promotions with a near-end physical store. Thereby there is no difficulty in informing every consumer of services about price bargaining and promotions for goods in the physical store and proceeding with them in real time, unlike what the conventional brick and mortar business has encountered. The near-end physical store may also reduce its operating costs by the invention, making it become a competitive advantage for both the business and consumers. Moreover, the invention may further combine reality games with goods promotions and thus bring more fun when the consumers interact with the store.

### BRIEF DESCRIPTION OF THE DRAWINGS

The above and other aspects, features and other advantages of the present invention will be more clearly understood from the following detailed description taken in conjunction with the accompanying drawings, in which:

FIG. 1A is a schematic diagram showing a basic architecture of an online bargaining system according to the invention;

FIG. 1B is an architecture diagram of the online bargaining system according to an embodiment of the invention; and

FIG. 2 is an architecture schematic diagram of an online goods promotion system according to the invention.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like components.

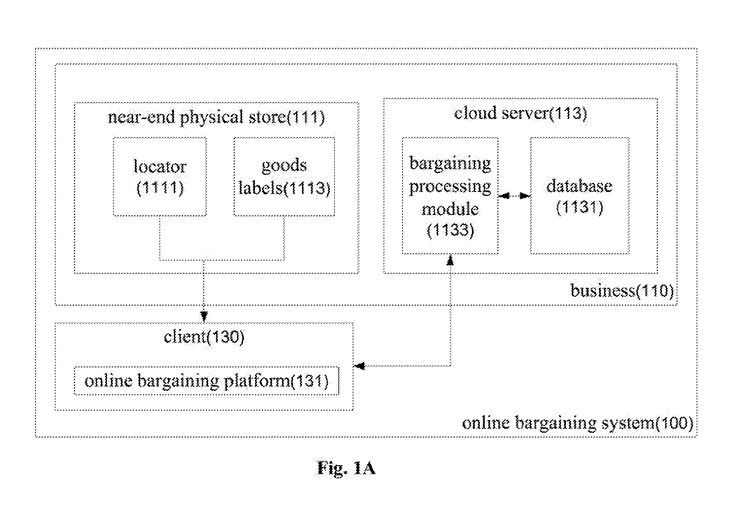

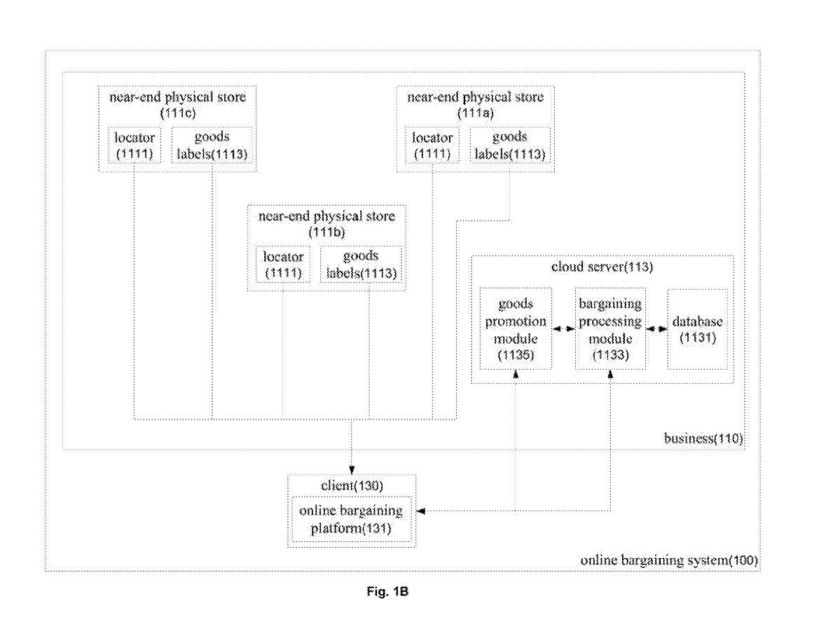

FIG. 1A shows a basic architecture of an online bargaining system according to the invention. As shown in FIG. 1A, the online bargaining system 100 of the invention includes a business 110 and a client 130.

The business 110 includes a near-end physical store 111 and a cloud server 113. The near-end physical store 111 refers to a brick and mortar shop such as department store, hypermarket and so on for selling goods. In the near-end physical store 111 there are provided a locator 1111 and goods labels 1113. The locator 1111 is used to output location information of the near-end physical store 111. The goods labels 1113 are provided corresponding to goods for sale in the near-end physical store 111 and contain goods identification information representing the goods for sale. Particularly, the goods identification information may include goods model information, goods codes, goods shape, goods brand recognition and other characters and symbols for recognizing the corresponding goods.

The cloud server 113 includes a database 1131 and a bargaining processing module 1133 (to be described later). The database 1131 stores the goods identification information representing the goods for sale, and allowable prices and bargaining procedures of the goods for sale in the near-end physical store 111. Generally, the allowable prices and bargaining procedures of the goods for sale may be valuable in different near-end physical stores 111.

The client 130 is preferably, but not limited to, a hand-held electronic device having screen display and network communication functions, such as smart phone, tablet, notebook and so on, which is electronic equipment taken along with a consumer. Alternatively, the client 130 may be electronic equipment fixed and provided in the near-end physical store 111, such as desktop computer, POS machine, etc., which can be operated by a consumer entering the near-end physical store 111. The client 130 includes an online bargaining platform 131. In practical operation, the online bargaining platform 131 can be implemented by installing APP or other software programs in the client 130. When the client 130 is in the near-end physical store 111, that is, the consumer is inside the physical store, the client 130 may login the online bargaining platform 131 and receive the location information transmitted from the locator 1111 to read a goods label 1113 corresponding to an item of goods for price bargaining (in a way of, but not limited to, images, sounds, text inputs, or other ways of reading). Then the client 130 sends a bargaining service request to the cloud server 113, and provides the received location information and the read goods label 1113.

The bargaining processing module 1133 of the cloud server 113 recognizes the item of goods for price bargaining according to the goods label 1113 read by the client 130, and recognizes the near-end physical store 111 where the client 130 is according to the location information received by the client 130. Then, the bargaining processing module 1133 searches an allowable price and a bargaining procedure for this item of goods in the near-end physical store 111 from the database 1131, and interacts with the client 130 through the online bargaining platform 131 to process the bargaining service request. In an embodiment, the client 130 further may provide an expected price for the item of goods for price bargaining to the cloud server 113, and sends the bargaining service request based on the expected price. Then, the bargaining processing module 1133 determines a difference between the expected price and the allowable price, and processes the bargaining service request according to the bargaining procedure based on the determined difference in price. For example, when the expected price is determined to be not lower than the allowable price, the expected price becomes a minimum based on which the bargaining processing module 1133 may interact with the client 130 for online bargaining for one or more times.

Preferably, the client 130 further may provide a third-party price for the item of goods for price bargaining (that is, a price of this item of goods being sold in another physical store) to the cloud server 113, and sends the bargaining service request based on the third-party price. Then, the bargaining processing module 1133 determines a difference between the third-party price and the allowable price, and processes the bargaining service request according to the bargaining procedure based on the determined difference in price. Moreover, the database 1131 of the cloud server 113 may further store the expected price or third-party price for the item of goods for price bargaining from the client 130, which serves as a reference for the business 110 to determine a reasonable price for this item of goods. For example, the business 110 may compare the physical store corresponding to the third-party price with the near-end physical store 111 in terms of locations, logistics costs, labor costs and other factors, so as to re-price the item of goods for price bargaining in the near-end physical store 111 at a reasonable price. Moreover, the business 110 may use the database 1131 to collect expected prices for the same item of goods for price bargaining from different clients 130, so as to know market purchase demand of this item of goods and reset the reasonable price, thereby improving market competitiveness of the item of goods.

In another embodiment, when the client 130 is in the near-end physical store 111, that is, the client 130 is taken along with the consumer in the near-end physical store 111, the client 130 may send identity information to the cloud server 113 through the online bargaining platform 131. The database 1131 of the cloud server 113 also stores history bargaining records corresponding to the identity information, such that the bargaining processing module 1133 searches the history bargaining records corresponding to the identity information from the database 1131, and interacts with the client 130 through the online bargaining platform 131 to process the bargaining service request. By such mechanism, the business 110 (that is, brick and mortar business owner) may know potential purchase will, goods preference, shopping habit and other related data for the client 130 (consumer), so as to process the bargaining service request from the client 130 in a targeted way and improve successfulness of bargaining. Moreover, as the database 1131 stores the history bargaining records of the client 130, it has collected long-term purchase data for the client 130, which may help the business 110 plan sales strategies and timely know the attractiveness of special goods to consumers, in order to adjust placement of goods for sale and number of stocks thereof.

FIG. 1B is an architecture diagram of the online bargaining system according to an embodiment of the invention. In this embodiment, the business 110 has a plurality of near-end physical stores 111a, 111b, 111c and a cloud server 113. The online bargaining system 100 of this embodiment has a similar architecture to that shown in FIG. 1A, but differs in that, in this embodiment, the cloud server 113 further includes a goods promotion module 1135. When the bargaining processing module 1133 processes the bargaining service request, it allows the goods promotion module 1135 to generate goods promotion means for the online bargaining platform 131 to interact with the client 130 and process the bargaining service request. Particularly, when the bargaining processing module 1133 determines the expected price inputted by the client 130 is lower than the allowable price of the item of goods for price bargaining in the near-end physical store 111, it outputs the bargaining procedure for activating the goods promotion module 1135 to generate the goods promotion means and continue interacting with the client 130 online. In another embodiment, the goods promotion means generated by the goods promotion module 1135 include goods marketing information that provides the client 130 with a promotion plan on a similar or recommended item of goods in respect to the item of goods for price bargaining. For example, if the item of goods for price bargaining is a certain pair of shoes for the client 130, the goods promotion module 1135 may, according to a model number of the pair of shoes, search same style shoes made by other brands in the near-end physical store 111 corresponding to the expected price of the client 130, or may show goods promotion information that the client 130 is entitled to discounts on goods by buying two or more pairs of shoes or reaching a certain purchase amount in one transaction. In another embodiment, the goods promotion means generated by the goods promotion module 1135 include an augmented reality task, which is designed based on the environment of the near-end physical store 111. The client 130 may be entitled to a discount plan for the item of goods for price bargaining (or a similar or recommended item of goods) when the augmented reality task is completed. For example, the augmented reality task generated by the goods promotion module 1135 is an augmented reality game for the client 130 to play based on the near-end physical store 111 serving as a game environment, such that the consumer may use a display screen of the hand-held electronic device to complete random or site-directed tasks in order to get related discount information of goods for sale in the near-end physical store 111, wherein the goods discount information can be in the form of characters, pictures, symbols or others, which may be equivalent goods discounts shown on the display screen of the hand-held electronic device, such as surprise gifts, treasures, discount coupons, cash coupons and so on, and may be price discounts on all items of goods or combined with discounts on other goods. It should be noted that, the goods promotion module 1135 may generate a particular one of the above goods promotion means according to the history bargaining records corresponding to the identity information of the client 130 stored in the database 1131 so as to interact with the client 130 in a targeted way and improve successfulness of bargaining and promotion on goods.

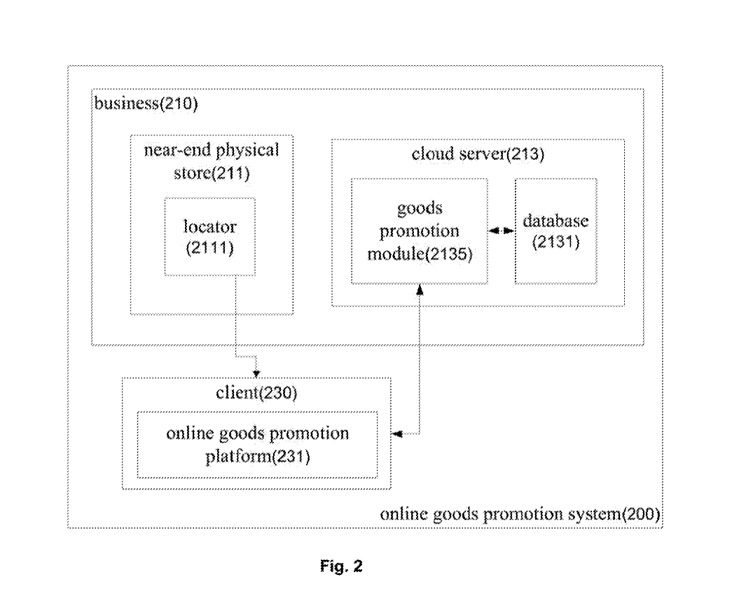

FIG. 2 is an architecture schematic diagram of an online goods promotion system according to the invention. As shown in FIG. 2, the online goods promotion system 200 of the invention similarly includes a business 210 and a client 230. The business 210 includes a near-end physical store 211 and a cloud server 213. The near-end physical store 211 provides goods for sale and includes a locator 2111. The cloud server 213 has a database 2131. The locator 2111 is used to output location information of the near-end physical store 211, and the database 2131 is used to store goods promotion procedures of the goods for sale in the near-end physical store 211.

The client 230 includes an online goods promotion platform 231. The client 230 is preferably, but not limited to, a hand-held electronic device having screen display and network communication functions, such as smart phone, tablet, notebook and so on, which is electronic equipment taken along with a consumer. Alternatively, the client 230 may be electronic equipment fixed and provided in the near-end physical store 211, such as desktop computer, POS machine, etc., which can be operated by a consumer entering the near-end physical store 211. As described above, the client 230 can login the online goods promotion platform 231 by installing APP. When the client 230 is in the near-end physical store 211, the client 230 may login the online goods promotion platform 231 and receive the location information outputted from the locator 2111 so as to send a goods promotion request to the cloud server 213 and provide the received location information.

The cloud server 213 further includes a goods promotion module 2135 for recognizing the near-end physical store 211 where the client 230 is according to the location information received by the client 230, for searching the goods promotion procedures from the database 2131 to generate goods promotion means, and for interacting with the client 230 through the online goods promotion platform 231 to process the goods promotion request. In an embodiment, the goods promotion means generated by the goods promotion module 2135 include goods marketing information that provides the client 230 with related promotion plans for the goods for sale in the near-end physical store 211 where the client 230 is. In another embodiment, the goods promotion means generated by the goods promotion module 2135 include an augmented reality task, which is designed based on the environment of the near-end physical store 211. The client 230 may be entitled to discount plans for the goods for sale when the augmented reality task is completed. For example, the augmented reality task generated by the goods promotion module 2135 is an augmented reality game for the client 230 to play based on the near-end physical store 211 serving as a game environment, such that the consumer may use a display screen of the hand-held electronic device to complete random or site-directed tasks in order to get related discount information of the goods for sale in the near-end physical store 211, wherein the goods discount information can be in the form of characters, pictures, symbols or others, which may be equivalent goods discounts shown on the display screen of the hand-held electronic device, such as discount coupons, cash coupons and so on.

Moreover, the online goods promotion system 200 of the invention further allows the client 230 to send identity information through the online goods promotion platform 231 to the cloud server 213 when the client 230 is in the near-end physical store 211, that is, the consumer with the client 230 is in the near-end physical store 211. The database 2131 further stores history purchase records corresponding to the identity information. The goods promotion module 2135 searches the corresponding history purchase records from the database 2131 according to the identity information, and interacts with the client 230 through the online goods promotion platform 231 to process the goods promotion request. By such mechanism, the business 210 (that is, brick and mortar business owner) may know potential purchase will, goods preference, shopping habit and other related data for the client 230 (consumer), so as to process the goods promotion request from the client 230 in a targeted way and improve successfulness of promotion. Moreover, as the database 2131 stores the history purchase records of the client 230, it has collected long-term purchase data for the client 230, thereby helping the business 210 plan sales strategies.

Therefore, the online bargaining system and the online goods promotion system of the invention provide an online platform allowing a consumer in a physical store to have online interactions of real-time price bargaining and promotions on goods for sale in the physical store with a business owning the physical store. Thereby there is no difficulty in informing every consumer of services about price bargaining and promotions for goods in the physical store and proceeding with them in real time, making the physical store become a competitive advantage for both the business and consumers. The invention may further combine reality games with goods promotions and thus bring more fun when the consumers interact with the store. Moreover, the invention may provide the business with long-term collected purchase data of the consumers, which may help the business plan sales strategies for the goods in the physical store and improve successfulness of goods selling.

The examples above are only illustrative to explain principles and effects of the invention, but not to limit the invention. It will be apparent to those skilled in the art that modifications and variations can be made without departing from the spirit and scope of the invention. Therefore, the protection range of the rights of the invention should be as defined by the appended claims.

What is claimed is:

1. An online bargaining system including:
a business including at least one near-end physical store and a cloud server, wherein,
the near-end physical store is for selling at least one item of goods, and includes:
a locator provided in the near-end physical store and for outputting location information; and
a goods label provided on the at least one item of goods and including goods identification information representing the at least one item of goods; and
the cloud server includes:
a database for storing the goods identification information representing the item of goods, and storing allowable prices and bargaining procedures for the at least one item of goods in the near-end physical store; and
a client including an online bargaining platform, wherein when the client is in the near-end physical store, through the online bargaining platform it receives the location information and reads goods identification information corresponding to an item of goods for price bargaining, so as to send a bargaining service request to the cloud server and provide the received location information and the read goods identification information; wherein,
the cloud server further includes a bargaining processing module, wherein the bargaining processing module recognizes the item of goods for price bargaining according to the goods identification information read by the client, and recognizes the near-end physical store where the client is according to the location information received by the client, so as to search an allowable price and a bargaining procedure corresponding to the item of goods for price bargaining from the database, and interact with the client through the online bargaining platform to process the bargaining service request.

2. The online bargaining system according to claim 1, wherein when the client is in the near-end physical store, it sends identify information to the cloud server through the online bargaining platform, and the database further stores history bargaining records corresponding to the identify information, such that the bargaining processing module searches the history bargaining records from the database according to the identify information so as to interact with the client through the online bargaining platform and process the bargaining service request.

3. The online bargaining system according to claim 1, wherein the client further provides an expected price for the item of goods for price bargaining to the cloud server and sends the bargaining service request based on the expected price, and the bargaining processing module further determines a difference between the expected price and the allowable price of the item of goods for price bargaining and processes the bargaining service request according to the difference being determined and the bargaining procedure.

4. The online bargaining system according to claim 3, wherein the client further provides a third-party price for the item of goods for price bargaining to the cloud server and sends the bargaining service request based on the third-party price, and the bargaining processing module further determines a difference between the third-party price and the allowable price of the item of goods for price bargaining and processes the bargaining service request according to the difference being determined and the bargaining procedure.

5. The online bargaining system according to claim 4, wherein the database further stores the expected price or third-party price for the item of goods for price bargaining from the client, so as to allow the business to determine a reasonable price for the item of goods for price bargaining.

6. The online bargaining system according to claim 4, wherein the cloud server further includes a goods promotion module, wherein when the bargaining processing module processes the bargaining service request according to the bargaining procedure, it allows the goods promotion module to generate goods promotion means used for interacting with the client through the online bargaining platform in order to process the bargaining service request, wherein the goods promotion means generated by the goods promotion module include goods promotion information for providing the client with promotion plans of similar or recommended items of goods corresponding to the item of goods for price bargaining, and include an augmented reality task designed based on the near-end physical store's environment, allowing the client when completing the augmented reality task to be entitled to discount plans on the item of goods for price bargaining or its similar or recommended items of goods.

7. An online goods promotion system including:
a business including at least one near-end physical store and a cloud server, wherein,
the near-end physical store is for selling at least one item of goods, and includes:
a locator provided in the near-end physical store and for outputting location information; and
the cloud server includes:
a database for storing goods promotion procedures for the item of goods in the near-end physical store; and
a client including an online goods promotion platform, wherein when the client is in the near-end physical store, it receives the location information through the online goods promotion platform, and sends a goods promotion request to the cloud server and provides the received location information; wherein,
the cloud server further includes a goods promotion module for recognizing the near-end physical store where the client is according to the location information received by the client, for searching the goods promotion procedures from the database to generate goods promotion means, and for interacting with the client through the online goods promotion platform to process the goods promotion request.

8. The online goods promotion system according to claim 7, wherein when the client is in the near-end physical store, it sends identity information through the online goods promotion platform to the cloud server, and the database further stores history purchase records corresponding to the identity information, such that the goods promotion module searches the history purchase records from the database according to the identity information, and interacts with the client through the online goods promotion platform to process the goods promotion request.

9. The online goods promotion system according to claim 7, wherein the goods promotion means generated by the goods promotion module include goods marketing information for providing promotion plans on the item of goods.

10. The online goods promotion system according to claim 7, wherein the goods promotion means generated by the goods promotion module include an augmented reality task designed based on the near-end physical store's environment, allowing discount plans on the item of goods to be provided by completing the augmented reality task.
